(19) United States
(12) Patent Application Publication
(10) Pub. No.: US 2009/0140835 A1
(43) Pub. Date: Jun. 4, 2009

(54) LED lamp control apparatus

(76) Inventor: Tung-Hsin You, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/987,596

(22) Filed: Dec. 3, 2007

(51) Int. Cl. G05B 19/00

(52) U.S. Cl. 340/5.2

(57) ABSTRACT

The present invention discloses an LED lamp control apparatus including wireless or electric cable LED driving module and control system transceiving module. A cable, wireless or electric cable module of the control system transceiving module is provided for encrypting an instruction by a microprocessor, and transmitting a signal from a bidirectional wireless or electric cable transceiver module, and a bidirectional wireless or electric cable transceiver module installed in the wireless or electric cable LED driving module receives the signal. After the LED lamp driver decrypts and confirms the signal, the microprocessor displays the LED lamp according to the instruction and the signal, and a wireless or cable transmission is provided for controlling the signal, so as to achieve the effects of saving time, effort and power, and enhance the product practicability and industrial use of the LED lamp control apparatus.

### BACKGROUND OF THE INVENTION

1. Field of the Invention

The present invention relates to an LED lamp control apparatus, comprising: wireless or electric cable LED driving module and control system transceiving module, such that a cable wireless or electric cable module in the control system transceiving module encrypts an instruction by a microprocessor, and a signal is transmitted by a bidirectional wireless or electric cable transceiver module, and the signal is received by the bidirectional wireless or electric cable transceiver module installed in the wireless or electric cable LED driving module. After the LED lamp driver decrypts and confirms the signal, the microprocessor displays the brightness and mixed colors of the LED lamp according to the instruction and the signal. The wireless or cable transmission is used for controlling the signal to achieve the effects of saving time, effort and power, and enhance the product practicability and industrial application of the LED lamp control apparatus.

2. Description of the Related Art

In recent years, light emitting diode (LED) is developed rapidly and continuously. Unlike a general incandescent light bulb, the light emitting diodes are cold fluorescent, and thus having the advantages of low power consumption, long life, no warm-up time, and quick response speed. In addition, LED also comes with a small volume and a shock resisting feature that are suitable for mass production, so that LED can be used for the applications that require small or array components, and it is used extensively as an indicating lamp or a display device of information, communication and electronic consumer products. In additional to the applications for various display devices and traffic signal lights, the LED can be used extensively in portable products, such as a backlight source for the screen of a mobile phone or a personal digital assistant (PDA). Particularly, when a backlight component module is selected to go with a liquid crystal display product, the light emitting diode is an indispensable key component.

For example, a common billboard device usually comes with a desired advertising related pattern (such as a slogan or a logo) printed on an exterior of a light emitting box, and adopts light sources in different modes of the box to express desired messages and main points to the general public.

However, the display used for the billboard device is generally limited by the advertising pattern (such as the slogan and logo) printed on the exterior of the box, since users cannot change the pattern for the advertising of other products, whenever the pattern is fixed for advertising of a particular product. Obviously, the prior art billboard device is not cost-effective, and also wastes tremendous labor and related resources for changing the display of the billboard device each time. In general, a connecting wire is required to provide power supply and signal transmission for the methods of lighting up and controlling a traditional LED lamp, and the material and construction costs of the connecting wires for the one-to-one connections may be acceptable, but high construction, material and maintenance costs will be incurred for the applications of a long-distance connection. In view of the foregoing shortcomings, the inventor of the present invention based on years of experience to conduct extensive experiments and modifications, and finally developed a wireless or electric cable LED lamp control apparatus in accordance with the present invention.

### SUMMARY OF THE INVENTION

The primary objective of the present invention is to overcome the shortcomings of the prior art by providing an LED lamp control apparatus, comprising: wireless or electric cable LED driving module and control system transceiving module, and a cable, wireless or electric cable module in the control system transceiving module is used to encrypt an instruction through a microprocessor, and then a bidirectional wireless or electric cable transceiver module sends out a signal. After a bidirectional wireless or electric cable transceiver module installed in the wireless LED driving module receives the signal, and the LED lamp driver decrypts and confirms the signal, the microprocessor will drive the display of the LED lamp according to the instruction and signal. A wireless or cable transmission is used for controlling the signal to achieve the effect of saving time, effort, and power consumption of the LED lamp control apparatus, so as to enhance the product practicability and industrial value.

To achieve the foregoing objective, the present invention provides an LED lamp control apparatus as illustrated by related drawings and described in detail as follows.

Referring to FIGS. 1 and 2, the present invention provides an LED lamp control apparatus, comprising: a wireless LED driving module 10 and a control system transceiving module 20.

The wireless LED driving module 10 is connected to an LED lamp 3 and contains:

a bidirectional wireless transceiver module 11, for receiving an instruction and a signal transmitted from a control system, or actively reporting conditions of operating the LED lamp 3 and peripheries of the LED lamp;

a microprocessor 12, for interpreting the instruction and the signal received by the bidirectional wireless transceiver module 11, and verifying whether or not the source of receiving the signal is authorized, and then transmitting the signal to the microprocessor 12;

an LED lamp driver 13, for driving one of the red (R), green (G) and blue (B) signal drivers or one of the ON and OFF signal drivers in the LED lamp 3; and

a control system transceiving module 20, coupled to the control system, and including:

a bidirectional wireless transceiver module 21, for communicating with a bidirectional wireless transceiver module 11 in the wireless LED driving module 10;

a microprocessor 22, for encrypting and processing a received program content, and sending out the program content through the bidirectional wireless transceiver module 21;

a cable module 23, for receiving the content of a program playback signal from the control system by a cable or wireless method.

Referring to FIG. 3 for another preferred embodiment of the present invention, an LED lamp control apparatus comprises an electric cable LED driving module 40 and a control system transceiving module 50.

The electric cable LED driving module 40 is coupled with an LED lamp 3 and contains:

a bidirectional power cable transceiver module 41, for receiving an instruction and a signal transmitted from a control system, or actively reporting conditions of operating the LED lamp 3 and peripheries of the LED lamp;

a microprocessor 42, for interpreting the instruction and the signal received by the bidirectional wireless transceiver module 41, and verifying whether or not the source of receiving the signal is authorized, and then transmitting the signal to the microprocessor 42;

an LED lamp driver 43, for driving one of the red (R), green (G) and blue (B) signal drivers or one of the ON and OFF signal drivers in the LED lamp 3; and

a control system transceiving module 50 is coupled with the control system, and contains:

a bidirectional power cable transceiver module 51, for communicating with a bidirectional power cable transceiver module 41 in the electric cable LED driving module 40;

a microprocessor 52, for encrypting and processing a received program content, and sending out the program content through a bidirectional power cable transceiver module 51; and

a cable module 53, for receiving the content of a program playback signal from the control system by an electric cable method.

### BRIEF DESCRIPTION OF THE DRAWINGS

FIG. 1 is a schematic view of an overall structure of the present invention;

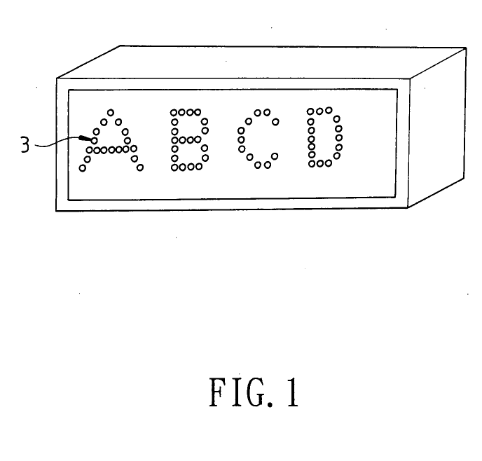

FIG. 2 is a schematic block diagram of the present invention; and

FIG. 3 is another schematic block diagram of the present invention.

### DETAILED DESCRIPTION OF THE PREFERRED EMBODIMENTS

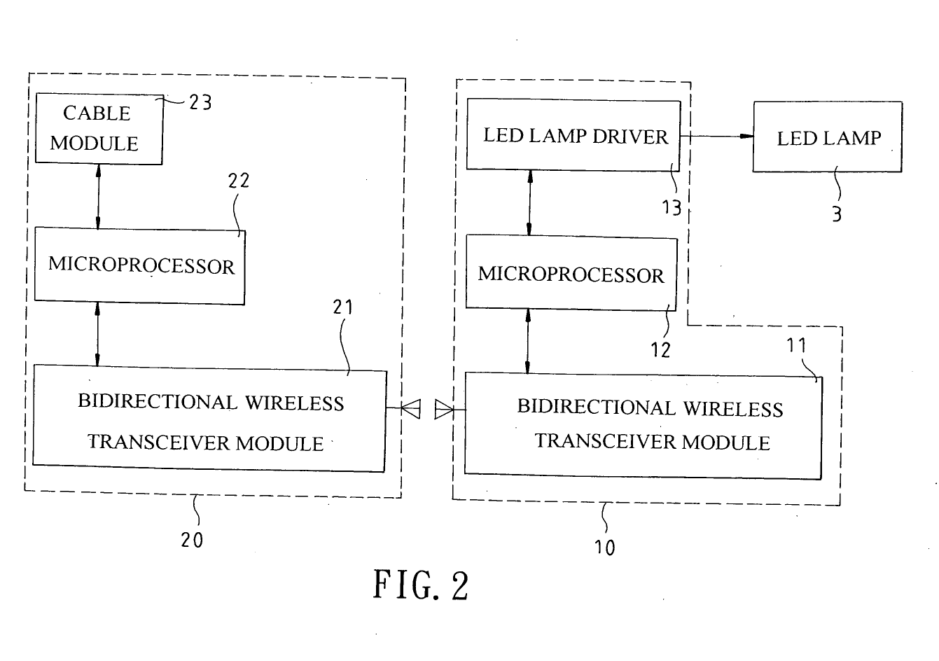

Referring to FIG. 2 for a block diagram of an overall structure of a wireless LED lamp control apparatus in accordance with the present invention, if a new program is played at the LED lamp 3, the cable module 23 will send a signal to a bidirectional wireless transceiver module 21 after a microprocessor 22 receives an instruction. After a bidirectional wireless transceiver module 11 installed in a wireless LED driving module 10 receives the signal, the bidirectional wireless transceiver module 11 will send the signal to the LED lamp driver 13 to decrypt and confirm whether or not the instruction is authorized, and then the microprocessor 12 displays the playback on the corresponding LED lamp 13 according to the principle of three mixed colors of RGB after the instruction and signal are confirmed.

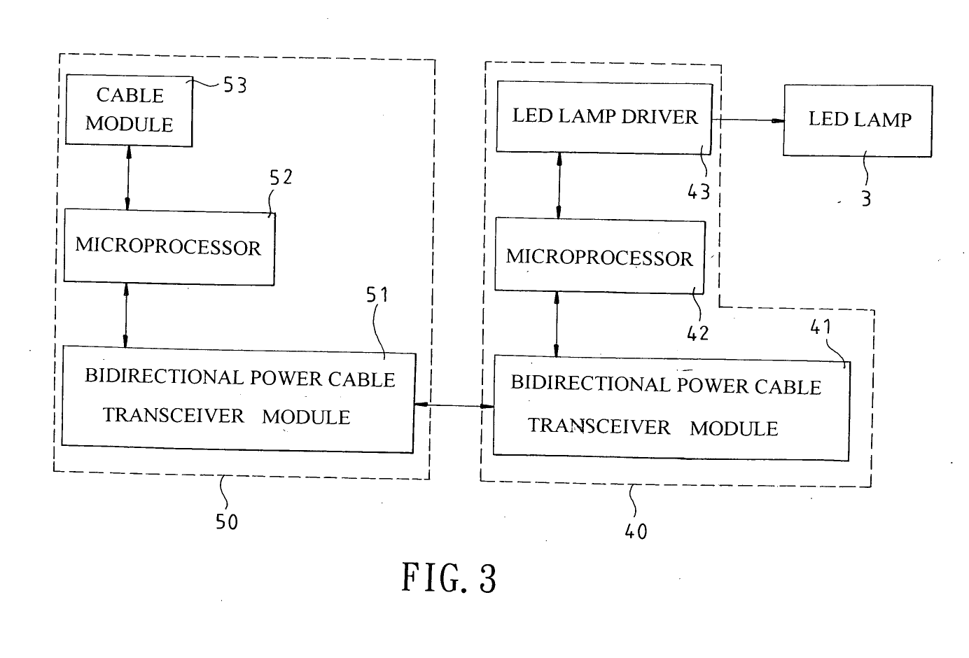

Further, the invention assembles each component as shown in FIG. 3 into a whole. If a new program requires displaying a playback at an LED lamp 3, the cable module 53 will receive an instruction, and the microprocessor 52 will encrypt and process the instruction, and then the bidirectional power cable transceiver module 51 sends out a signal. After the bidirectional power cable transceiver module 41 installed in the electric cable LED driving module 40 receives the signal, LED lamp driver 43 will decrypt and confirm whether or not the instruction is authorized. The microprocessor 42 displays the playback on a corresponding LED lamp 3 according to the instruction and the signal based on the principle of three mixed colors of RGB.

In the method of the present invention, a wireless or electric cable transmission is used for controlling the signal, but the characteristic of the invention not resides on the wireless or power transmission technology, but also uses these technologies to achieve the same effect of the prior art that requires lots of labors and materials. The invention can be used for controlling the LED lamp by applying the aforementioned method to save time, effort and power.

While the invention is described in some detail with reference to certain illustrated embodiments, it is to be understood that there is no intent to limit it to those embodiments. On the contrary, the aim is to cover all modifications, alternatives and equivalents falling within the spirit and scope of the invention as defined by the appended claims.

In summation of the description above, the invention is in compliance with the requirements of patent application, and is thus duly filed for a patent application.

What is claimed is:

1. An LED lamp control apparatus, comprising:
a wireless LED driving module, coupled with an LED lamp, and containing:
a bidirectional wireless transceiver module, for receiving an instruction and a signal transmitted from the control system, or actively reporting conditions of operating the LED lamp and peripheries of the LED lamp;
a microprocessor, for interpreting the instruction and the signal received by the bidirectional wireless transceiver module, and verifying whether or not the source of receiving the signal is authorized, and then transmitting the signal to the microprocessor;
an LED lamp driver, for driving one of the red (R), green (G) and blue (B) signal drivers or one of the ON and OFF signal drivers in the LED lamp; and
a control system transceiving module, coupled to the control system, and including:
a bidirectional wireless transceiver module, for communicating with the bidirectional wireless transceiver module inside the wireless LED driving module;
a microprocessor, for encrypting and processing the received instruction signal, and transmitting the encrypted instruction signal through the bidirectional wireless transceiver module;
a cable module, for receiving the content of a program playback signal from the control system by a cable or wireless method.

2. An LED lamp control apparatus, comprising:
an electric cable LED driving module, coupled with an LED lamp, and containing:
a bidirectional power cable transceiver module, for receiving an instruction and a signal transmitted from the control system, or actively reporting conditions of operating the LED lamp and peripheries of the LED lamp;
a microprocessor, for interpreting the instruction and the signal received by the bidirectional wireless transceiver module, and verifying whether or not the source of receiving the signal is authorized, and then transmitting the signal to the microprocessor;
an LED lamp driver, for driving one of the red (R), green (G) and blue (B) signal drivers or one of the ON and OFF signal drivers in the LED lamp; and
a control system transceiving module, coupled with the control system, and containing:
a bidirectional power cable transceiver, for communicating with the bidirectional power cable transceiver module inside the electric cable LED driving module;
a microprocessor, for encrypting and processing the received instruction signal, and transmitting the encrypted instruction signal through the bidirectional power cable transceiver module;
a cable module, for receiving the content of a program playback signal from the control system by an electric cable method.
